(19) United States
(12) Patent Application Publication
(10) Pub. No.: US 2021/0016457 A1
(43) Pub. Date: Jan. 21, 2021

(54) BLADE ASSEMBLIES AND METHODS

(71) Applicant: Sanford L.P., Atlanta, GA (US)

(72) Inventors: Patrick K. Shields, Grand Rapids, MI (US); Austin Laniosz, Willowbrook, IL (US); Evan Fulford, Portage, MI (US); Daniel P. Sedlecky, Cumming, GA (US); Steven Jay Muske, Marietta, GA (US)

(21) Appl. No.: 16/929,959

(22) Filed: Jul. 15, 2020

Related U.S. Application Data
(60) Provisional application No. 62/874,440, filed on Jul. 15, 2019.

(51) Int. Cl. B26B 5/00

(52) U.S. Cl. CPC B26B 5/00

(57) ABSTRACT

Blade assemblies and methods for their use are provided herein. The blade assemblies include a blade coupled to a grip portion, and a handle that is configured to be selectively secured to the grip portion, to allow for removable attachment of the blade to the handle.

### CROSS-REFERENCE TO RELATED APPLICATIONS

This application claims priority benefit of U.S. Provisional Application No. 62/874,440, filed Jul. 15, 2019, the disclosure of which is incorporated by reference herein in its entirety.

### FIELD OF DISCLOSURE

This disclosure generally relates to blade assemblies, and more specifically relates to mechanisms for replaceable blades.

### BACKGROUND

Utility and craft knives, and other blade assemblies (referred to interchangeably, herein), have been in widespread use for centuries. Knives are used for a variety of applications in art studios, homes, offices, and classrooms. Knives are known for being sharp and precise tools that can handle even the most delicate of jobs. The blade's edge of the knife can wear out from time to time with constant use and replacing the blade can be a hassle. Indeed, most commercially available knives have an integral non-replaceable blade that must be sharpened to maintain its usefulness.

To enable replacement of blades in a safe manner, some knives come with a detachable mechanism opposite the sharp end of the blade. Alternatively, some blades come with a configuration that allows for a fastener to grip onto or through the blade. While the fastener will hold onto a blade even if a strong force is applied to the blade, the average user will be intimidated by exchanging the new blade onto a perfectly usable handle. Various configurations to solve this issue have been utilized throughout the years, but none offers a truly user-friendly approach in addition to accounting for the safety of the user.

Accordingly, a need exists to create a simple, user-friendly, and safe mechanism that overcomes one or more of the disadvantages of current blade designs and allow for a safe method of replacing used blades.

### SUMMARY

In one aspect, blade assemblies are provided having a blade, a grip portion including an apertural forward end and an aft end coupled to the blade, with at least one male detent disposed within the apertural forward end, and a handle having a post portion configured to selectively secure into the apertural forward end of the grip portion.

In another aspect, blade assemblies are provided having a grip portion with a plurality of apertures, wherein at least one aperture of the plurality of apertures includes a male detent within the at least one aperture, a blade coupled to the grip portion, and a handle having a post portion adapted for securely receiving the male detent, such that the post portion is configured to be inserted and pivoted into the at least one aperture of the grip portion, so that the post portion secures the grip portion to the handle.

In yet another aspect, blade assemblies are provided including a grip portion having an apertural first end, an apertural second end, and a grippable surface, the apertural second end including a male detent within an interior surface of the apertural second end, a blade coupled to the apertural first end, and a post portion extending from a handle, the post portion having a channel configured to be selectively secured within the apertural second end.

### BRIEF DESCRIPTION OF THE DRAWINGS

The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a perspective view of one embodiment of a disengaged grip portion and a post portion of a handle of a blade assembly.

FIG. 2A is an exploded perspective view of one embodiment of a disengaged blade and grip portion.

FIG. 2B is a cross-sectional perspective view of one embodiment of the blade of FIG. 2A coupled to the grip portion.

FIG. 3A is an exploded perspective view of one embodiment of a disengaged blade assembly.

FIG. 3B is a perspective view of the assembly of FIG. 3A being engaged.

FIG. 3C is a perspective view of the assembly of FIG. 3A after engagement.

FIG. 4A is a cross-sectional perspective view of one embodiment of a post portion and a handle engaged with the grip portion of one embodiment of a blade assembly.

FIG. 4B is a cross-sectional perspective view of one embodiment of the post portion and the handle engaged with the grip portion of FIG. 4A.

FIG. 5 is a perspective view of one embodiment of a blade assembly.

FIG. 6A is a perspective view of one embodiment of a blade assembly.

FIG. 6B is a perspective view of the blade assembly of FIG. 6B with the carrier unattached from the handle

FIG. 7 is a perspective view of one embodiment of a blade assembly.

FIG. 8A is a perspective view of one embodiment of a blade assembly.

FIG. 8B is a partial perspective view of the blade of FIG. 8A being advanced from the assembly.

FIG. 8C is a partial perspective view of the blade of FIG. 8A being removed from the handle.

FIG. 9 is a perspective view of one embodiment of a blade assembly.

FIG. 10A is a rear perspective view of one embodiment of the disengaged grip portion and the post portion of a blade assembly.

FIG. 10B is a front perspective view of the blade assembly of FIG. 10A.

FIG. 11 is a cross-sectional view of one embodiment of a blade coupled to a grip portion of a blade assembly.

FIG. 12 is a perspective view of one embodiment of a post portion and handle of a blade assembly.

FIG. 13 is a top view of one embodiment of a blade assembly.

FIG. 14 is a perspective view of one embodiment of a blade assembly of FIG. 13.

FIG. 15A is a partial perspective view of one embodiment of a grip portion of a blade assembly.

FIG. 15B is a magnified cross-sectional view of the grip portion of FIG. 15A.

FIG. 15C is a magnified cross-sectional view of the grip portion of FIG. 15A.

FIG. 16 is an exploded perspective view of one embodiment of a grip portion and a post portion of a blade assembly.

FIG. 17 is an exploded perspective view of one embodiment of a disengaged grip portion and a post portion of a blade assembly.

FIG. 18 is a perspective view of one embodiment of a disengaged grip portion and a post portion of a blade assembly.

FIG. 19 is a cross-sectional perspective view of one embodiment of a disengaged grip portion and a post portion of a blade assembly.

FIG. 20 is a perspective exploded view of one embodiment of a blade and a grip portion of a blade assembly.

FIG. 21 is a front exploded view of the assembly of FIG. 20.

FIG. 22 is a perspective exploded view of the assembly of FIG. 20.

FIG. 23 is a front exploded view of the assembly of FIG. 20.

FIG. 24 is an x-ray view of one embodiment of the blade coupled to the grip portion in the assembly of FIG. 20.

FIG. 25 is a front exploded view of one embodiment of a grip portion and a post portion of a blade assembly.

FIG. 26 is a perspective view of one embodiment of a post portion of a blade assembly.

FIG. 27 is a perspective x-ray view of one embodiment of the grip portion of a blade assembly.

FIG. 28 is a front view of one embodiment of the post portion of a blade assembly.

FIG. 29 is a side view of one embodiment of the post portion of a blade assembly.

FIG. 30 is a perspective view of one embodiment of the post portion and the handle of a blade assembly.

FIG. 31 is a side view of the post portion and handle of FIG. 30.

FIG. 32 is a side view of the post portion and handle of FIG. 30.

FIG. 33 is a side view of the post portion and handle of FIG. 30.

FIG. 34 is a perspective view of one embodiment of a grip portion of a blade assembly.

FIG. 35 is a rear view of one embodiment of the grip portion of FIG. 34.

FIG. 36 is a front view of the grip portion of FIG. 34.

FIG. 37 is a rear view of one embodiment of the grip portion of FIG. 34.

FIG. 38 is a cross-sectional view of one embodiment of a grip portion of a blade assembly, as in FIG. 35.

FIG. 39 is a side view of one embodiment of the grip portion of a blade assembly, as in FIG. 37.

FIG. 40 is a cross-sectional view of one embodiment of the grip portion of a blade assembly of FIG. 39.

FIG. 41 is a front view of one embodiment of a first portion of a blade plug of a blade assembly.

FIG. 42 is a perspective view of the first portion of the blade plug of FIG. 41.

FIG. 43 is a side view of the first portion of the blade plug of FIG. 41.

FIG. 44 is a front view of a second portion of a blade plug of a blade assembly.

FIG. 45 is a side view of the second portion of the blade plug of FIG. 44.

FIG. 46 is a perspective view of the second portion of the blade plug of FIG. 44.

FIG. 47 is a perspective view of one embodiment of a blade assembly cap of a blade assembly.

### DETAILED DESCRIPTION

The removable blade assemblies described herein allow for easy attachment and removal of replacement blades on a handle. A blade assembly generally may include a blade, a gripping portion coupled to the blade, and a handle configured to receive the gripping portion. The present disclosure includes non-limiting embodiments of blade assemblies with removable blades. In some embodiments, the blade assembly attaches via a detent contained within an aperture of a grip sliding within a channel on one end of a handle. In other embodiments, the blade assembly attaches via a male detent on a post portion of the handle sliding within a channel of the grip portion. For example, the blade assembly may contain multiple detents configured to slide within a channel on either the post portion or the grip portion. In some embodiments, the blade assembly includes a blade contained within an enclosed carrier that slidably locks onto the handle, in which the carrier may be configured to eject the blade as the handle is inserted into the carrier. In some embodiments, the blade assembly includes a magnet connection between the handle and the blade.

The embodiments are described in detail herein to enable one of ordinary skill in the art to practice the blade assembly, although it is understood that other embodiments may be utilized and that logical changes may be made without departing from the scope of the disclosure. Reference is made herein to the accompanying drawings illustrating some embodiments of the disclosure, in which use of the same reference numerals indicates similar or identical items.

Throughout the disclosure, depending on the context, singular and plural terminology may be used interchangeably.

In one aspect, a blade assembly includes a blade, a grip portion, a post portion, and a handle. The grip portion has an apertural forward end and an aft end coupled to the blade. The apertural forward end may include at least one male detent, a channel, or some other attachment mechanism disposed within the apertural forward end. The handle may include the post portion extending from a distal end of the handle. The post portion may include a channel, detent, or some other attachment mechanism disposed thereon. The post portion is configured to selectively lock into the apertural forward end of the grip portion. Together, once the post portion locks into the grip portion, the handle may aptly move the blade in coordination with any movement by the handle. One benefit to the interlocking mechanisms is the blade and grip portion can be replaced with a new blade and grip portion onto the post portion once a sharp blade becomes dull. While the embodiments herein are generally described with reference to the grip portion including an apertural end and the handle including a post portion, it should be understood that these features alternatively be exchanged, such that the handle includes the apertural end portions described herein and the grip portion coupled to the blade includes a corresponding post portion.

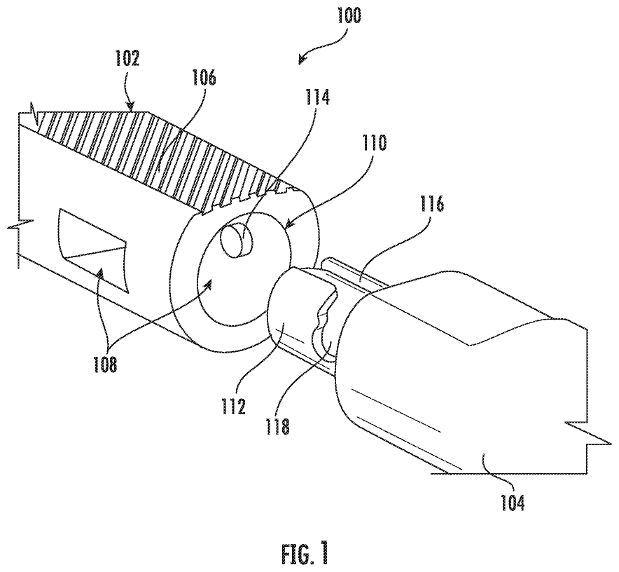

In certain embodiments, as shown in FIG. 1, a blade assembly 100 includes a grip portion 102 configured to engage with a blade 120 (not shown) and a post portion 112 of a handle 104. For example, the grip portion 102 may include an apertural end 110, an aft end coupled to the blade 120, and a male detent 114 within the apertural end 110. The grip portion 102 may be any suitable shape and size configured to allow a user to grip the surface for attaching the grip portion 102 to the post portion 112. In some embodiments, the grip portion 102 is substantially cylindrical or elliptical in cross-section. In other embodiments, the grip portion 102 may be rectangular, triangular, or some other three-dimensional shape.

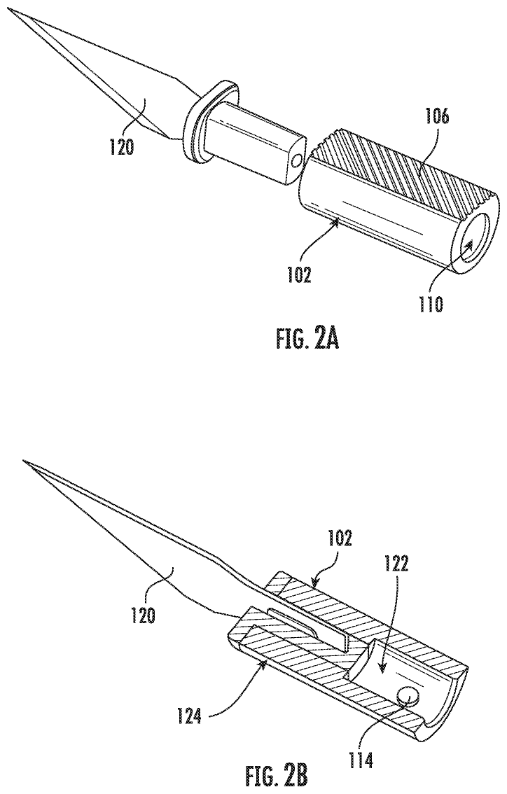

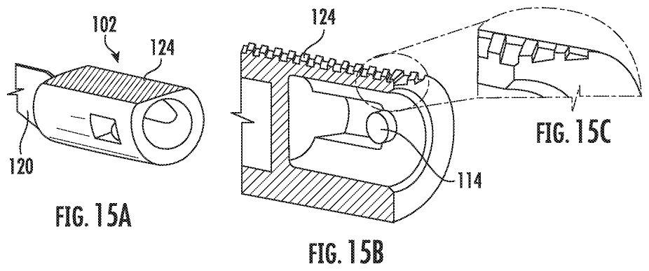

In some embodiments, as shown in FIG. 2B, the grip portion 102 includes an interior surface 122 and an exterior surface 124. The grip portion 102 may include a textured or smooth surface on an interior surface 122 or exterior surface 124. For example, the grip portion 102 may have a grippable, relatively flattened, textured surface on at least one side of the external surface 124. For example, as shown in FIG. 2A, the grip portion 102 may be cylindrical on most of the external surface, and the rest of the surface may have a flattened, non-cylindrical surface. The grippable surface 106 may be beneficial to a user while attaching the grip portion 102 to the handle 104. Further, the grippable surface 106 may be beneficial while the blade is in use to ensure the blade does not slip from a user's grip. As shown in FIGS. 15A-C, the grip portion may be over-molded on the blade 120.

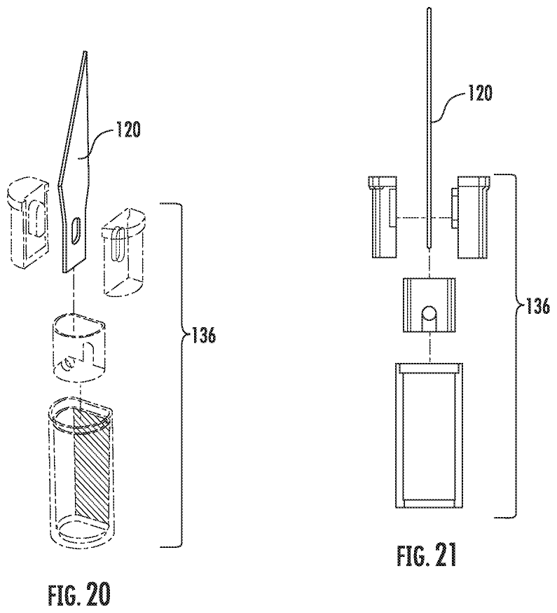

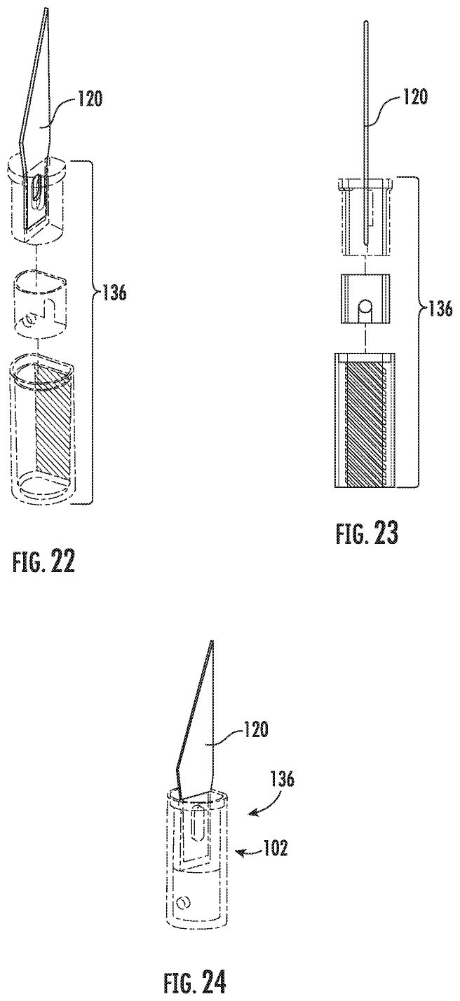

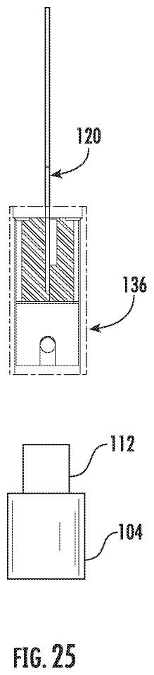

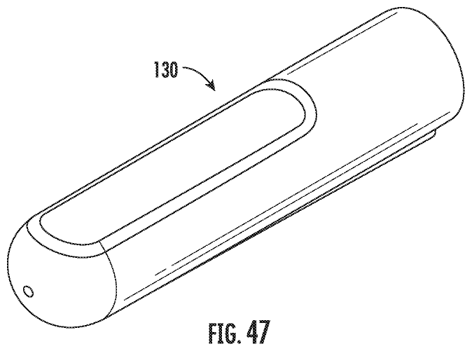

In some embodiments, as in FIG. 1, the grip portion 102 includes a plurality of apertures 108. In some embodiments, as in FIG. 1, at least one of the plurality of apertures 108 may be configured to receive a post portion 112, a blade plug 136 (as shown in FIGS. 20-25), a blade 120, and/or a safety cap 130 (as shown in FIG. 47). For example, a safety cap 130 may have two male detents that snap into place once the detents slide over each aperture on the grip portion 102.

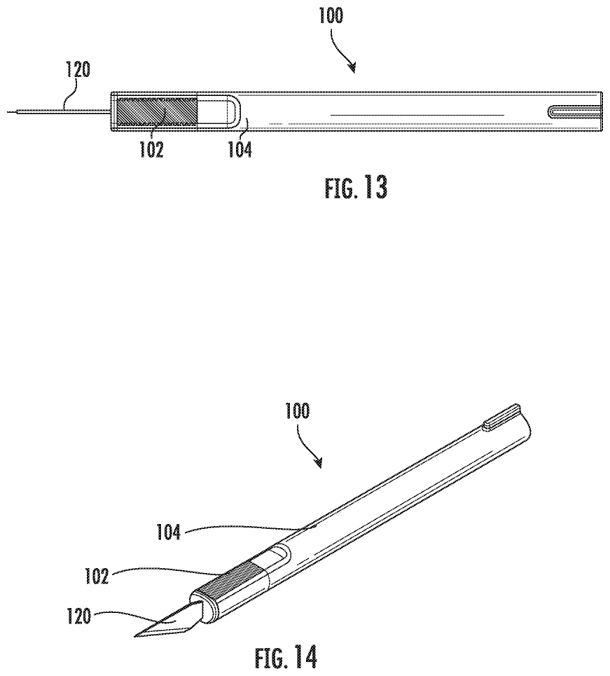

For example, one of the plurality of apertures 108 may include the apertural end 110. The apertural end 110 of the grip portion 102 may be configured to receive a post portion 112 from a handle 104 to secure the blade 120 to the handle 104 and selectively lock these components together (e.g., as seen in FIGS. 13-14, the grip portion 102 and the post portion 112 (not visible) from the handle 104 are securely connected). The interior surface 122 of the grip portion 102 may include at least one male detent 114 configured to slide into a channel 116 on the post portion 112 of the handle 104. The male detent 114 may be configured to lock the grip portion 102 into place once the male detent 114 slides from the attachment end of the channel 116 to the opposing end of the channel 116. As used herein, the term “attachment end” refers to the distal end of the handle where the male detent 114 is introduced to or enters the channel 116 of the post portion 112.

In certain embodiments, as seen in FIG. 1, the blade assembly includes 100 a handle 104 and a post portion 112 with a channel 116 extending therealong. As used herein, the term “handle” refers to an elongated shape configured to be held by a user. The handle may selectively attach to the blade and the grip portion. In some instances, the handle 104 may be an elongated shape configured to be used as a grip for the blade 120 (as shown in FIGS. 13-14). For example, the handle 104 may be a solid cylindrical handle. The handle 104 may be a variety of other shapes, including an oblong shape or an ergonomic shape configured to fit to a user's hand. The handle 104 may be smooth or textured. For example, the handle 104 may be textured along its length or at on one end. For example, the handle 104 may have a serrated or ribbed surface. The handle 104 may be composed of polyethylene terephthalate, polyethylene, polyvinyl chloride, polypropylene, polystyrene, polylactic acid, polycarbonate, acrylic, acetal, nylon, acrylonitrile butadiene styrene, aluminum, brass, copper, stainless steel, or another metal, metal alloy, or plastic.

In some embodiments, as in FIG. 1, a post portion 112 extends from a distal end of the handle 104. The post portion 112 may mimic the shape of the handle 104 or be of a different shape than the handle. For example, the post portion 112 may complement the apertural end 110 of the grip portion 102. In some embodiments, as in FIG. 1, the post portion 112 has at least one channel 116 disposed on the surface of the post portion 112. At least a portion of the channel 116 may start at one end of the post portion 112, such as at an opening at the edge of the post portion 112, which allows for entry of the detent 114 into the channel in use.

At least a portion of the channel 116 may extend in a direction parallel with the longitudinal axis of the handle 104. In other embodiments, as shown in FIGS. 4A-4B, the channel 116 radially extends around the post portion 112 from the grip portion 102 (partially shown). In some instances, at least a portion of the channel may be disposed on the post portion 112 in another manner.

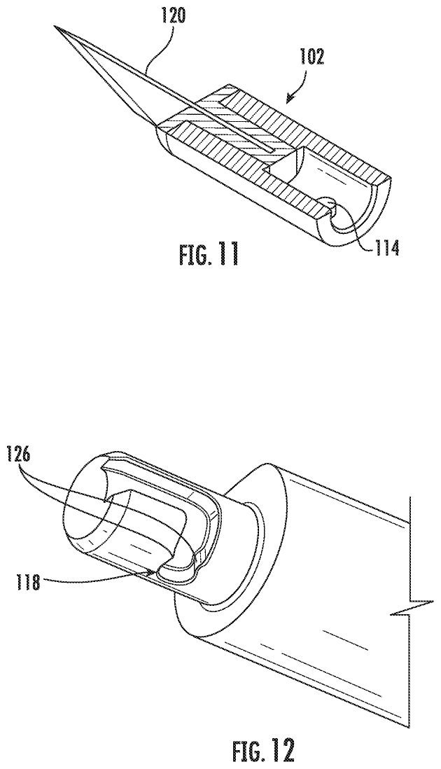

As seen in FIG. 1, a first portion of the channel 116 is disposed parallel to the handle 104 on the post portion 112. A second portion of the channel 116 may then turn substantially perpendicularly from the first portion of the channel 116. At the end of the second portion of the channel 116, a locking detent 118 may end the channel 116. The locking detent 118, as seen in FIGS. 11-12, may include a rounded surface behind two bumps 126 in the channel 116. In some embodiments, the locking detent 118 is configured to hold the male detent 114 of the grip portion 102 in place. Advantageously, the locking detent 118 and male detent 114 may hold the blade 120 of blade assembly 100 in place as well as provide for easy replacement of the blade for the average user.

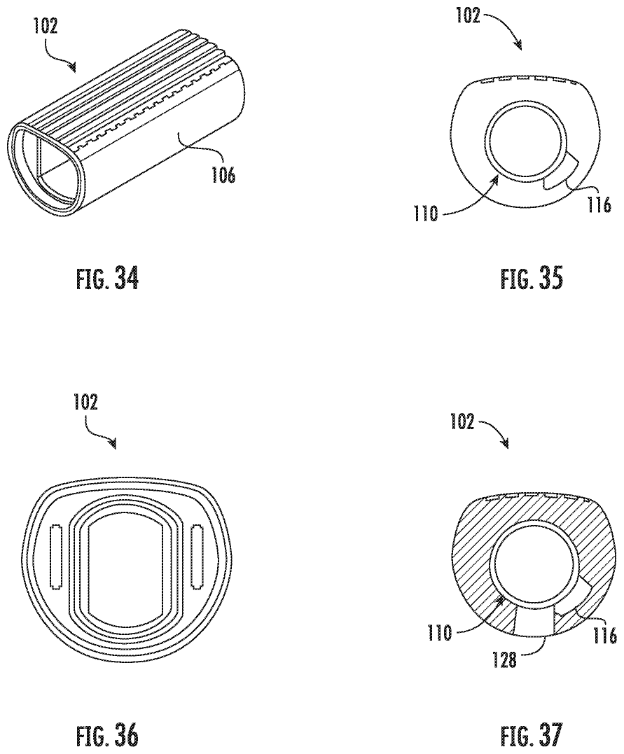

In some embodiments, as shown in FIGS. 34-40, the grip portion 102 includes the channel 116. In such instances, the post portion 112 may be associated with the handle. For example, multiple detents may be disposed on the post portion 112 that align with the channel(s) of the grip portion.

In certain embodiments, such as in FIG. 1, to engage the post portion 112 with the apertural end 110, the male detent 114 aligns with the channel 116. In some instances, multiple male detents may be disposed on the grip portion 102 and align with multiple channels. Once the male detent 114 aligns with the channel 116 (such as with the opening of the channel defined at an end of the post 112), the male detent 114 slides along the channel to be secured therein. In some embodiments, the channel may be configured to turn about a 1/8 inch turn into the locking detent 118. In other embodiments, male detent 114 may be configured to turn about a ¼ inch turn into the locking detent 118. In some instances, the grip portion turns between about 30 and about 150 degrees to lock the male detent 114 into the locking detent 118. As used herein, the term “about” refers to a range of +/− two percent of the unit of measurement stated thereafter. In some instances, the locking detent grips the at least one male detent 114 until a sufficient force rotates the grip portion 102 towards an entrance of the at least one channel 116, to allow for selective removal of the male detect from the channel when an appropriate removal force is applied.

In certain embodiments, the post portion 112 and/or the grip portion 102 are composed of plastic. In some instances, the material properties of the grip portion and the post portion 112 may include ABS, nylon, polycarbonate, machined or cast aluminum, magnesium, zinc, steel or other suitable material allowing for this interaction. In certain embodiments, the grip portion 102 is ultrasonically welded to the blade 120.

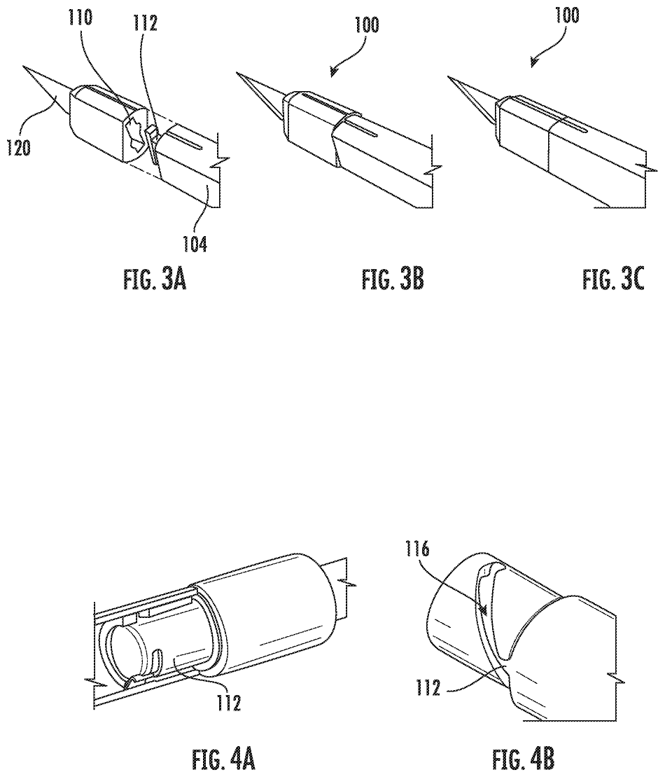

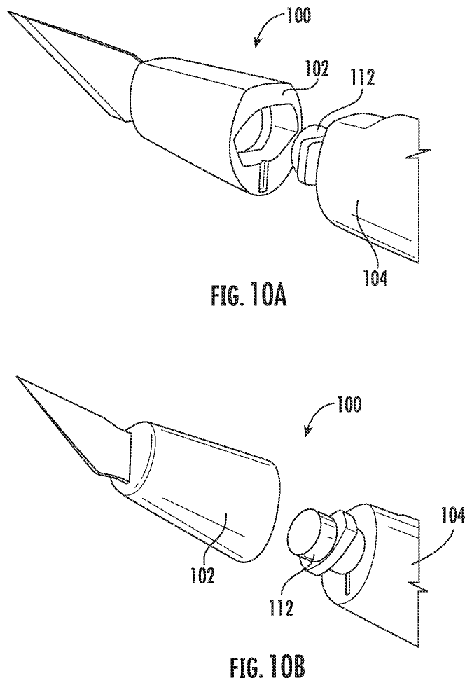

In some embodiments, as in FIGS. 3A-3C, 10A-10B, the post portion 112 is a “t-shape” that inserts into a complimentary apertural end 110 of a grip portion 102. For example, two posts coupled on the distal end of the handle 104 may form the “t-shape”. For example, a first post may extend from the handle 104 and a second post may attach perpendicularly to the first post (i.e., forming a “t-shape”). The first and second posts may be separate posts that are coupled and/or may be integrally formed. The post portion 112 may twist within the apertural end 110 to lock the blade 120 onto the handle 104.

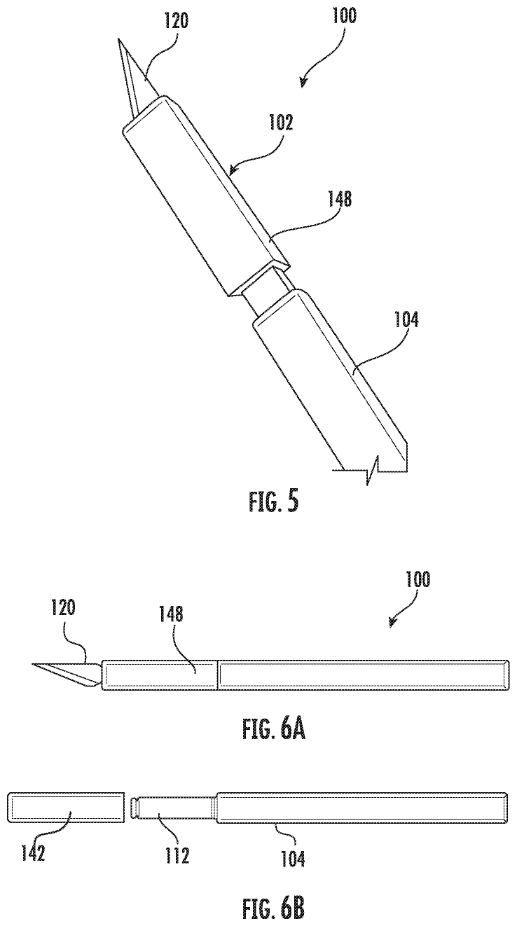

In some embodiments, as in FIGS. 5 and 6A-B, a blade 120 is fully enclosed in a carrier 148 while it is unattached from the handle 104. The handle 104 has a post portion 112 that extends from a distal end of the handle 104. As the post portion 112 is inserted into the carrier, the blade 120 is correspondingly advanced out of an aperture of the carrier 148. The carrier 148 snaps onto the handle 104 once the blade 120 is fully extended. If the carrier 148 is removed from the post portion 112 of the handle 104, the blade 120 will retract within the carrier 148. The carrier 148 may be composed of clear or colored plastic.

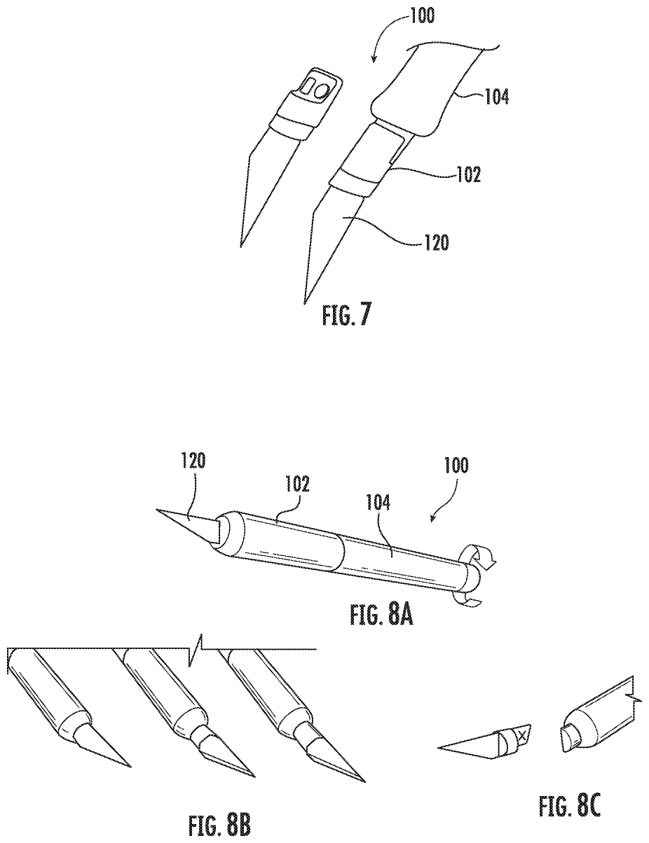

In some embodiments, as in FIGS. 7 and 8A-C, a blade with an over-molded grip portion 102 includes a magnet (or magnet attaching material) at one end of the grip portion 102. The handle 104 contains another magnet (or magnet attaching material) to which the magnet of the grip portion mates to secure the blade 120. The handle contains a portion that selectively extends from one end and retracts and extends the blade within the handle upon actuation of a turn knob at an opposite end of the handle.

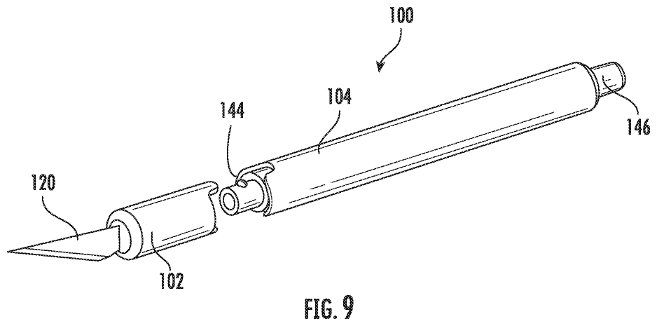

In some embodiments, as in FIG. 9, the replaceable blade assembly 100 includes a plunger 146 at one end of the handle that actuates push-button spring locks 144. The push-button spring locks are configured to engage the grip portion 102, and thereby the blade 120. In some instances, the grip portion 102 includes corresponding cavities within the grip portion 102 to engage the spring locks 144.

In certain embodiments, as shown in FIG. 16, a blade assembly 100 includes a grip portion 102 configured to engage with a blade 120 and a post portion 112 of a handle 104. For example, the grip portion 102 may include an apertural end and an aft end attached to the blade.

The grip portion may include a channel 116 within the apertural forward end for receiving the post portion 112 and male detent 114.

The grip portion 102 may be a shape configured to allow a user to grip the surface for engaging the grip portion 102 to the post portion 112. As discussed herein, in some instances, the grip portion 102 may be substantially cylindrical. For example, the grip portion 102 may have mostly rounded exterior and at least one flattened side. The grip portion 102 may include a textured or smooth surface on an interior surface 122 or exterior surface 124. For example, the grip portion 102 may have a grippable surface 106 on one side of the cylindrical structure. The grippable surface 106 may be beneficial to a user while attaching the grip portion 102 to the handle 104. The grippable surface 106 may be beneficial while the blade is in use to ensure the blade does not slip from a user's grip. In some embodiments, the grip portion 102 includes at least one locking aperture 128. The at least one locking aperture 128 may be configured to receive at least one male detent 114.

In some embodiments, as in FIG. 16, the interior of the apertural end 110 includes a channel 116 configured to receive the at least one male detent 114 disposed on the post portion 112 of the handle 104. The male detent 114 may be configured to lock the grip portion 102 into place once the male detent 114 slides to the end of the channel 116. In certain embodiments, as in FIG. 16, to engage the handle 104 with the grip portion 102, the male detent 114 aligns with the channel 116. In other embodiments, multiple male detents align with multiple channels. Once the male detent 114 aligns with the channel 116, the male detent 114 slides along the channel and may be configured to turn about an 1/8 inch turn into the locking aperture 128.

In some embodiments, the grip portion 102 is composed of resilient material (e.g., Acrylonitrile butadiene styrene). The grip portion 102 may allow for expansion when the male detent 114 slides within the channel 116 to the locking aperture 128 in which the male detent 114 operably snaps into place.

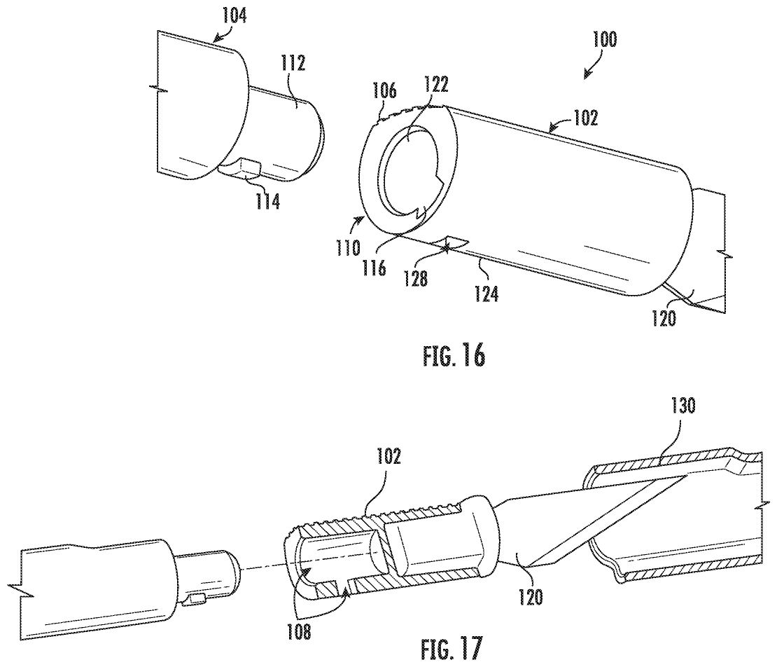

In some embodiments, as in FIG. 17, the grip portion 102 includes a plurality of apertures 108. For example, one of the plurality of apertures 108 includes an apertural end 110. The apertural end 110 of the grip portion 102 may be configured to receive a post portion 112 from a handle 104 to connect the blade to the handle 104 and selectively lock onto one another. The grip portion 102 and post portion 112 may lock onto one another (e.g., as seen in FIGS. 13-14, the grip portion 102 and the post portion 112 (not pictured) from the handle 104 are connected).

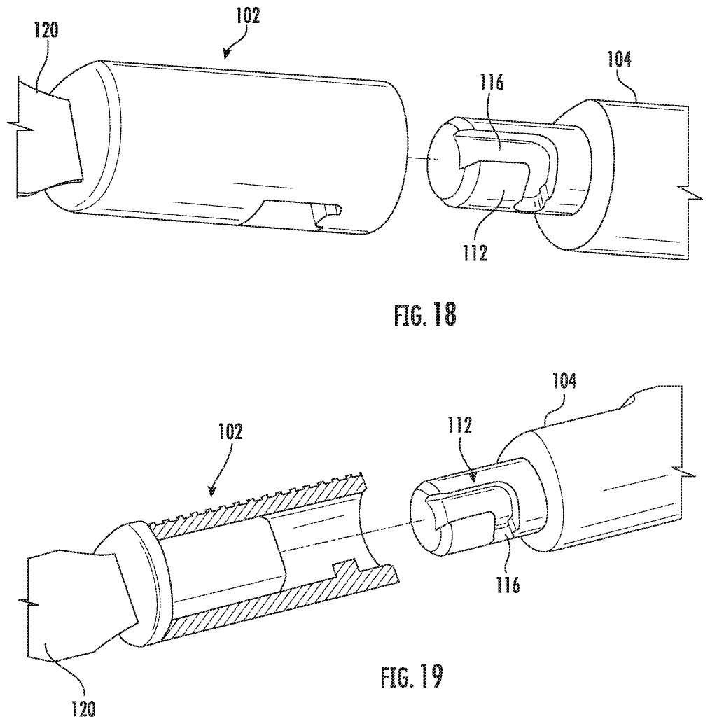

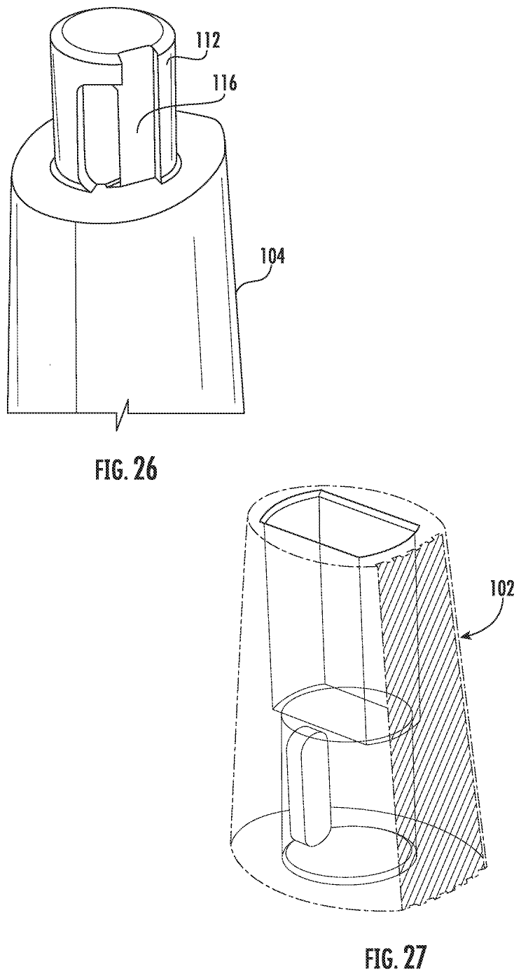

FIGS. 18 and 19 show another embodiment of a grip portion 102 and handle 104 having suitable post portion 112 and channel 116 for securing the grip portion 102. FIGS. 26 and 27 show another embodiment of a grip portion 102 (without the blade) having an apertural end with a male detent that has an elongated, linear shape and a corresponding handle 104 with post 112 and channel 116 for securing the detent.

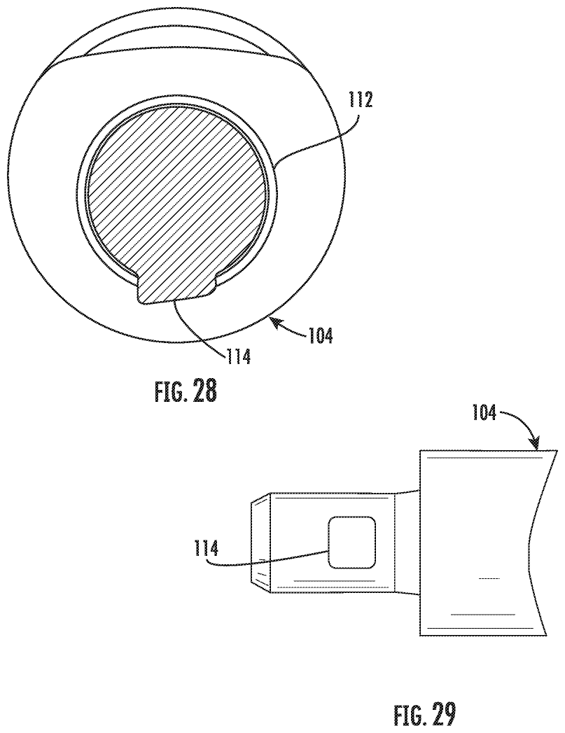

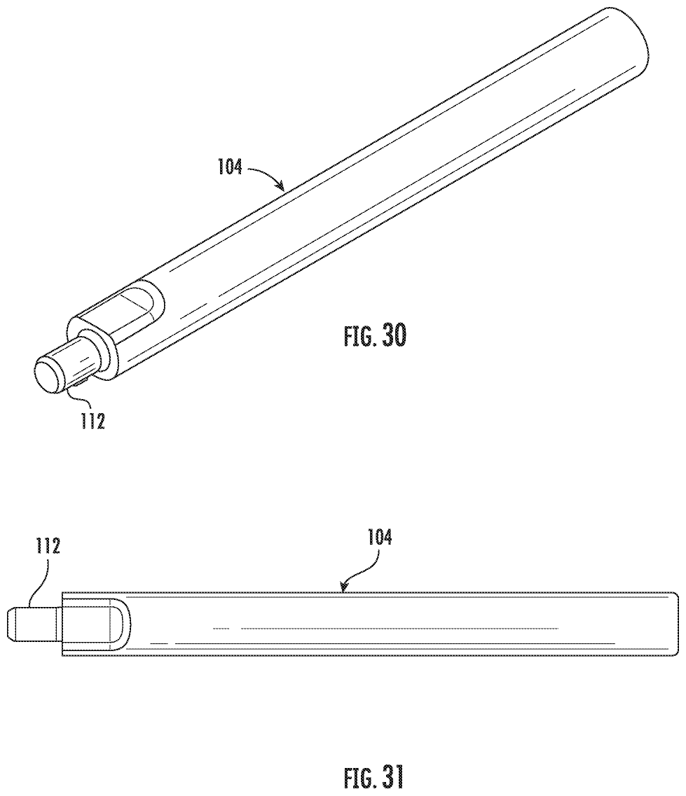

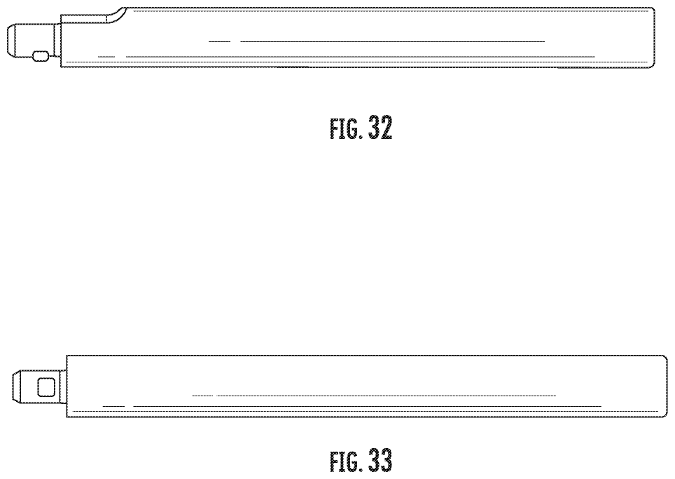

In certain embodiments, as seen in FIGS. 28-33, a handle 104 includes a post portion 112 with a male detent 114. The handle 104 may be used as a grip for the blade 120 once the grip portion 102 is engaged with the post portion 112. For example, the handle 104 may be a solid cylindrical handle. The handle 104 may be a variety of other shapes, including an oblong shape or a shape configured to fit to a user's hand. The handle 104 may be smooth or textured. At one distal end of the handle 104, a post portion 112 extends therefrom. In some instances, the post portion 112 may mimic the shape of the handle 104. In other instances, the post portion 112 may be of a different shape of the handle and complement the apertural end 110 of the grip portion 102.

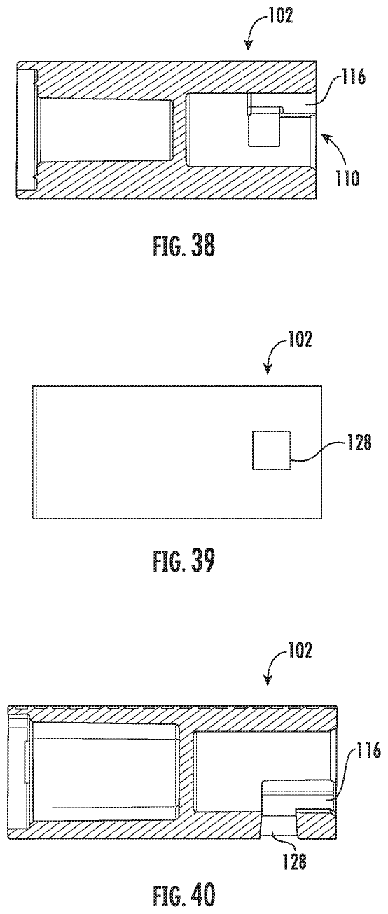

In some embodiments, as seen in FIGS. 37-38 and 40, the channel 116 begins at one end of the apertural end 110. For example, a first portion of the channel 116 may be parallel to a longitudinal direction of the grip portion 102 along the grip portion's interior surface 122. A second portion of the channel 116 may then turn perpendicularly from the first portion of the channel. At the end of the second portion of the channel 116, a locking aperture 128 may end the channel 116. The locking aperture 128, as seen in FIGS. 39-40, includes a square opening at the end of the channel 116. In some instances, the locking aperture 128 may be configured to hold the male detent 114 of the post portion 112 in place. Advantageously, the locking aperture 128 and male detent 114 will hold the blade 120 of blade assembly 100 in place as well as provide easy replacement of the blade for the average user.

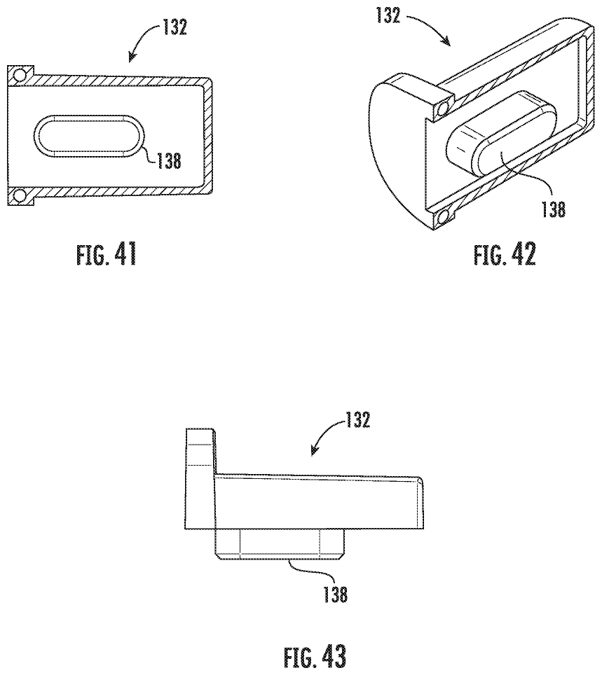

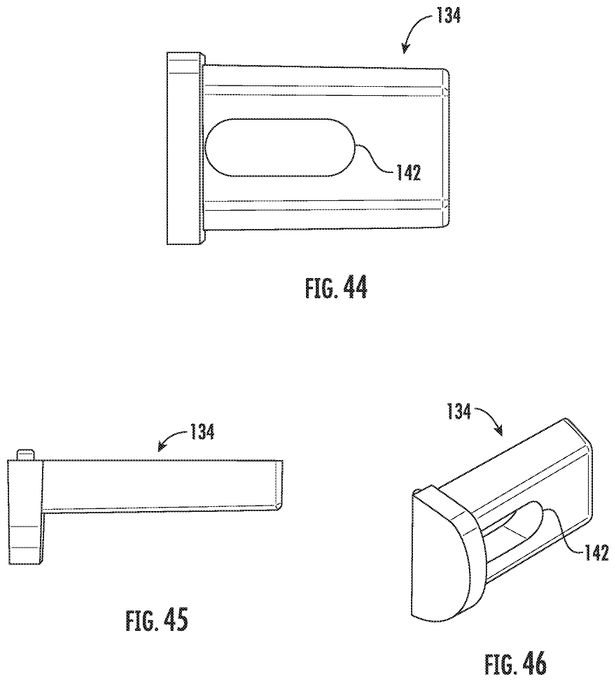

In some embodiments, as in FIG. 41-46, a first portion 132 and a second portion 134 of a blade plug 136 (as shown assembled in FIGS. 20-25) are shown. In some instances, the first portion 132 of the blade plug 136 includes an elongated detent 138 on one side. The elongated detent 138 may be configured to protrude through an aperture 140 of the blade 120, to secure the blade 120 therin. In some embodiments, as in FIG. 44-46, a second portion 134 of the blade plug 136 includes an elongated aperture 142 configured to receive the elongated detent 138 of the first portion 132 of the blade plug 136. After the first portion 132 and the second portion 134 engages through the aperture 140 of the blade 120, the blade plug 136 may slide within the grip portion 102 (as seen in FIGS. 20-25) to secure the blade to the grip portion 102.

In some embodiments, the blade 120 may be composed of stainless steel. In other embodiments, the blade 120 may be composed of carbon steel, tool steel, alloy steel, cobalt, titanium alloy, ceramic, obsidian, or plastic. The blade 120 may include a flat piece of steel sharpened along one edge and dulled along an edge positioned opposite to the sharpened edge.

The blade 120 may have an elongated surface configured to be held in place within the grip portion 102 by the blade plug 136.

It will be apparent to those skilled in the art that various modifications and variations can be made to the present disclosure without departing from the scope of the invention. Thus, it is intended that the present disclosure cover the modifications and variations of this invention provided they come within the scope of the appended claims and their equivalents.

What is claimed is:

1. A blade assembly, comprising:
a blade;
a grip portion comprising an apertural forward end and an aft end coupled to the blade, wherein at least one male detent is disposed within the apertural forward end; and
a handle comprising a post portion configured to selectively secure into the apertural forward end of the grip portion.

2. The blade assembly of claim 1, wherein the grip portion comprises an exterior surface and an interior surface, the exterior surface comprising a textured surface.

3. The blade assembly of claim 1, wherein the handle is configured to slide into the apertural forward end to secure into the apertural forward end upon rotation of the at least one male detent between about 45 degrees and about 90 degrees.

4. The blade assembly of claim 1, wherein the grip portion comprises a plurality of apertures, wherein the plurality of apertures are configured to receive the post portion, a safety cap, and/or the blade.

5. The blade assembly of claim 1, wherein the post portion comprises at least one channel configured to receive the at least one male detent.

6. The blade assembly of claim 5, wherein the at least one channel comprises a first portion extending in a direction substantially parallel with a longitudinal axis of the handle and a second portion in connection with and extending away from the first portion.

7. The blade assembly of claim 6, wherein the second portion comprises a locking detent configured to selectively lock the post portion to the apertural forward end.

8. The blade assembly of claim 7, wherein the grip portion is configured to slide over the post portion and rotate less than 180 degrees to lock the at least one male detent into the locking detent, wherein the locking detent grips the at least one male detent until a sufficient force rotates the grip portion towards an entrance of the at least one channel.

9. The blade assembly of claim 7, wherein the grip portion is configured to slide over the post portion and rotate equal to or more than 180 degrees to lock the at least one male detent into the locking detent, wherein the locking detent grips the at least one male detent until a sufficient force rotates the grip portion towards an entrance of the at least one channel.

10. The blade assembly of claim 1, wherein the grip portion comprises a bump along an outside edge of the grip portion configured to engage a groove disposed on the first end of the handle.

11. The blade assembly of claim 1, wherein the handle comprises a bump at the first end of the handle configured to engage a groove disposed along an outside edge of the grip portion.

12. A blade assembly, comprising:
a grip portion comprising a plurality of apertures, wherein at least one aperture of the plurality of apertures comprises a male detent within the at least one aperture;
a blade coupled to the grip portion; and
a handle comprising a post portion adapted for securely receiving the male detent, such that the post portion is configured to be inserted and pivoted into the at least one aperture of the grip portion, so that the post portion secures the grip portion to the handle.

13. The blade assembly of claim 12, wherein the post portion comprises a channel.

14. The blade assembly of claim 13, wherein the channel comprises a first portion and a second portion, the first portion of the channel comprises an entrance and extending in a direction substantially parallel to a longitudinal axis of the handle, the second portion of the channel comprises at least one locking detent and extends away from the first portion.

15. The blade assembly of claim 12, wherein at least one aperture of the plurality of apertures are configured to receive a safety cap.

16. The blade assembly of claim 12, wherein the grip portion comprises a textured surface.

17. The blade assembly of claim 12, wherein the at least one aperture and the post portion are circular in cross-sectional shape.

18. The blade assembly of claim 12, wherein the blade is coupled to the grip portion by a fastener, an adhesive, a blade plug, or a frictional aperture of the grip portion.

19. The blade assembly of claim 12, wherein the blade comprises:
an aperture; and
a blade plug comprising a first portion and a second portion, wherein the first portion comprises a male detent and the second portion comprises a female detent, wherein the first portion is configured to selectively attach to the second portion through the aperture of the blade, wherein the blade plug slides within the aft end of the grip portion.

20. A blade assembly, comprising:
a grip portion comprising an apertural first end, an apertural second end, and a grippable surface, the apertural second end comprising a male detent within an interior surface of the apertural second end;
a blade coupled to the apertural first end; and
a post portion extending from a handle, the post portion comprising a channel configured to be selectively secured within the apertural second end.
